(19) United States
(12) Patent Application Publication
(10) Pub. No.: US 2026/0118917 A1
(43) Pub. Date: Apr. 30, 2026

(54) PROTECTIVE COVER FOR ELECTRONIC DEVICE AND MANUFACTURING METHOD THEREOF

(71) Applicant: Chicony Electronics Co., Ltd., New Taipei City (TW)

(72) Inventor: Wen-Bin Chen, New Taipei City (TW)

(21) Appl. No.: 18/986,147

(22) Filed: Dec. 18, 2024

(30) Foreign Application Priority Data
Jul. 26, 2024 (TW) 113127990

(51) Int. Cl. G06F 1/16

(52) U.S. Cl. CPC G06F 1/1679; G06F 1/1669

(57) ABSTRACT

A protective cover for an electronic device includes a first plate, a second plate, and a flexible bent sheet connected between the first plate and the second plate. The first plate includes a first outer layer, a first inner layer, and movable blocks. A first outer adhesive layer is on a surface of the first outer layer, a first inner adhesive layer is on a surface of the first inner layer, the movable blocks are adhered between the first outer adhesive layer and the first inner adhesive layer, and the movable blocks are spaced apart from each other. The flexible bent sheet includes a flexible outer layer, a flexible inner layer, and a solidified thermoplastic adhesive layer adhered between the flexible outer layer and the flexible inner layer, so that the flexible bent sheet is maintained in a bent state. A manufacturing method of the protective cover is also provided.

### CROSS-REFERENCE TO RELATED APPLICATION

This non-provisional application claims priority under 35 U.S.C. § 119 (a) to patent application No. 113127990 filed in Taiwan, R.O.C. on Jul. 26, 2024, the entire contents of which are hereby incorporated by reference.

### BACKGROUND

### Technical Field

The instant disclosure relates to a protective cover, in particular, to a protective cover for an electronic device and a manufacturing method thereof.

### Related Art

Tablet-type computers (For example, smart phones or tablets) have already become common portable electronic devices. To allow the tablet-type computers to be provided with extension functions or to prevent the tablet-type computers from being impacted by other objects, many users tend to equip the tablet-type computers with protective covers.

### SUMMARY

For a foldable protective cover known to the inventor, the cover plate is usually formed by several blocks, and the blocks are swingable relative to each other, so that the blocks can be folded as a stand, and the stand can be provided for supporting the tablet-type computer, thereby allowing the user to watch the tablet-type computer with a better viewing angle. However, after the cover plate of the protective cover is unfolded, if an external force is not applied to the blocks yet, the swinging directions of the blocks are uncontrolled. As a result, the user needs to use his/her hands to apply forces on the blocks to fold the blocks as the expected stand configuration. Consequently, the operation of the foldable protective cover cause inconvenience and trouble for the user.

In view of this, in one embodiment, a protective cover for an electronic device is provided, and the protective cover comprises a first plate, a flexible bent sheet, and a second plate. The flexible bent sheet is connected between the first plate and the second plate, so that the first plate and the second plate can be overlaid or unfolded relative to each other. The first plate comprises a first outer layer, a first inner layer, and a plurality of movable blocks. A first outer adhesive layer is on a surface of the first outer layer, a first inner adhesive layer is on a surface of the first inner layer, the movable blocks are adhered between the first outer adhesive layer and the first inner adhesive layer, and the movable blocks are spaced apart from each other, so that the movable blocks are swingable relative to each other. The flexible bent sheet comprises a flexible outer layer, a flexible inner layer, and a solidified thermoplastic adhesive layer, and the solidified thermoplastic adhesive layer is adhered between the flexible outer layer and the flexible inner layer, so that the flexible bent sheet is maintained in a bent state.

In another embodiment, a manufacturing method of a protective cover for an electronic device is provided. The manufacturing method comprises preparing an outer skin and an inner skin, wherein the outer skin comprises a first outer layer and a flexible outer layer integrally connected to each other, and the inner skin comprises a first inner layer and a flexible inner layer integrally connected to each other; disposing a first outer adhesive layer on a surface of the first outer layer, disposing a first inner adhesive layer on a surface of the first inner layer, and disposing a thermoplastic adhesive layer between the flexible outer layer and the flexible inner layer; adhering a plurality of movable blocks between the first outer adhesive layer and the first inner adhesive layer and adhering the thermoplastic adhesive layer to the flexible outer layer and the flexible inner layer, wherein the movable blocks are spaced apart from each other, so that the movable blocks are swingable relative to each other; heating the thermoplastic adhesive layer and bending the flexible outer layer, the thermoplastic adhesive layer, and the flexible inner layer; and cooling the thermoplastic adhesive layer to form a solidified thermoplastic adhesive layer, so that the flexible outer layer, the solidified thermoplastic adhesive layer, and the flexible inner layer form a flexible bent sheet, and the flexible bent sheet is maintained in a bent state.

Based on above, in the protective cover for an electronic device according to one or some embodiments of the instant disclosure, the adhesive layer between the flexible outer layer and the flexible inner layer of the flexible bent sheet is the solidified thermoplastic adhesive layer, so that the flexible bent sheet is maintained in a bent state. Therefore, when the first plate and the second plate are unfolded relative to each other, the flexible bent sheet can generate a torsion to drive the movable blocks of the first plate to swing relative to each other, so that the movable blocks are formed as a predetermined configuration. Moreover, when the first plate and the second plate are overlaid relative to each other, the torsion can also prevent the first plate and the second plate from being detached from each other easily to provide a better protection performance.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a protective cover according to an exemplary embodiment of the instant disclosure;

FIG. 2 illustrates an exploded view of the protective cover according to the exemplary embodiment of the instant disclosure;

FIG. 3 illustrates a partial cross-sectional view of the protective cover according to the exemplary embodiment of the instant disclosure;

FIG. 4 illustrates an unfolded schematic view of the protective cover according to the exemplary embodiment of the instant disclosure;

FIG. 5 illustrates a schematic view showing the operation of the protective cover according to the exemplary embodiment of the instant disclosure;

FIG. 6 illustrates a flowchart of a manufacturing method of a protective cover according to some exemplary embodiments of the instant disclosure;

FIG. 7 illustrates a partial lateral view of the protective cover according to the exemplary embodiment of the instant disclosure;

FIG. 8 illustrates a partial cross-sectional view of a thermoplastic adhesive layer of a protective cover according to a first embodiment of the instant disclosure;

FIG. 9 illustrates a partial cross-sectional view of a thermoplastic adhesive layer of a protective cover according to a second embodiment of the instant disclosure;

FIG. 10 illustrates a partial cross-sectional view of a thermoplastic adhesive layer of a protective cover according to a third embodiment of the instant disclosure;

FIG. 11 illustrates a partial cross-sectional view of a thermoplastic adhesive layer of a protective cover according to a fourth embodiment of the instant disclosure;

FIG. 12 illustrates a schematic view showing that a thermoplastic adhesive layer of a protective cover according to an exemplary embodiment of the instant disclosure is to be processed;

FIG. 13 illustrates a schematic view of the process following after FIG. 12;

FIG. 14 illustrates a schematic view showing that a thermoplastic adhesive layer of a protective cover according to another exemplary embodiment of the instant disclosure is to be processed; and

FIG. 15 illustrates a partial cross-sectional view of a solidified thermoplastic adhesive layer of a protective cover according to an exemplary embodiment of the instant disclosure.

### DETAILED DESCRIPTION

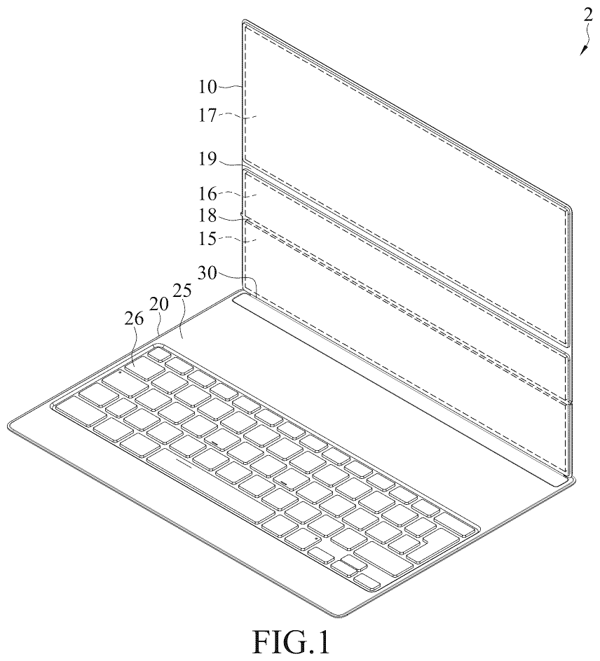

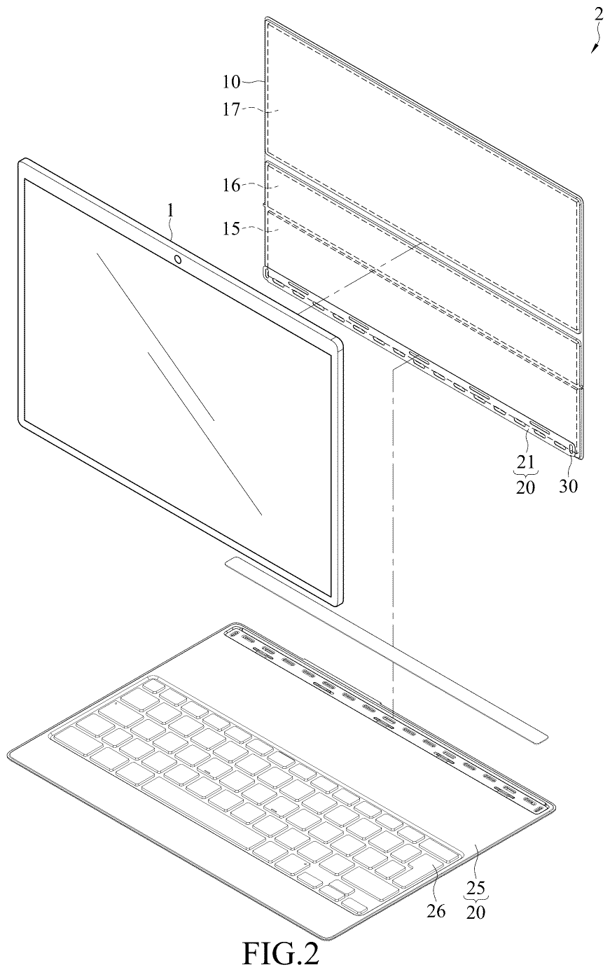

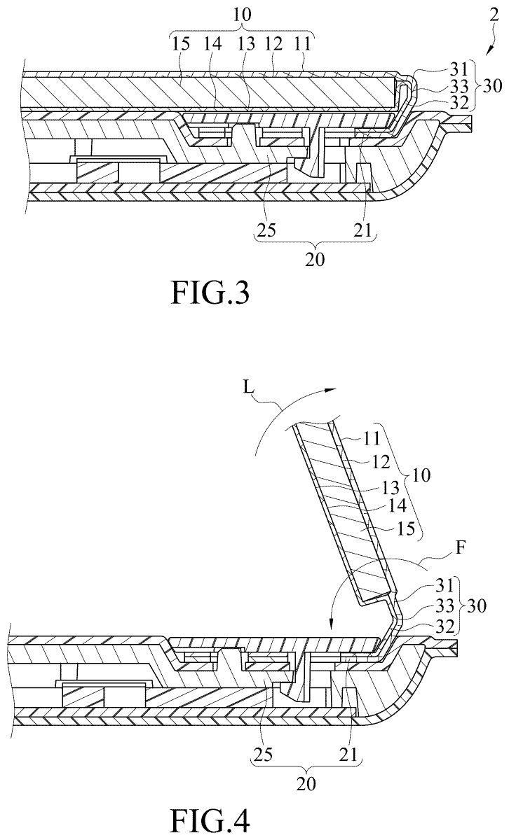

FIG. 1 illustrates a perspective view of a protective cover according to an exemplary embodiment of the instant disclosure. FIG. 2 illustrates an exploded view of the protective cover according to the exemplary embodiment of the instant disclosure. FIG. 3 illustrates a partial cross-sectional view of the protective cover according to the exemplary embodiment of the instant disclosure. As shown in FIG. 1 to FIG. 3, in this embodiment, the protective cover 2 comprises a first plate 10, a second plate 20, and a flexible bent sheet 30, and the flexible bent sheet 30 is connected between the first plate 10 and the second plate 20. The flexible bent sheet 30 is made of a flexible material such as leather, silicone, plastic, or other soft materials. Therefore, through the flexibility of the flexible bent sheet 30, the first plate 10 and the second plate 20 can be overlaid or unfolded relative to each other.

As shown in FIG. 1 and FIG. 2, the first plate 10 of the protective cover 2 is adapted to be assembled with an electronic device 1; for example, the electronic device 1 may be a smart phone, a tablet computer, or the like. In some embodiments, the assembling between the first plate 10 and the electronic device 1 may be achieved through magnetically-adhering, engaging, adhering, or other manners, so that the electronic device 1 can be detached from the first plate 10.

As shown in FIG. 1 to FIG. 3, the first plate 10 comprises a first outer layer 11, a first inner layer 13, and a plurality of movable blocks. In this embodiment, the movable blocks comprise a first movable block 15, a second movable block 16, and a third movable block 17, but the number of the movable blocks is not limited thereto. Moreover, a first outer adhesive layer 12 is on a surface of the first outer layer 11, and a first inner adhesive layer 14 is on a surface of the first inner layer 13. The first movable block 15, the second movable block 16, and the third movable block 17 are adhered between the first outer adhesive layer 12 and the first inner adhesive layer 14, so that the first movable block 15, the second movable block 16, and the third movable block 17 are enclosed in the first outer layer 11 and the first inner layer 13.

As shown in FIG. 1 to FIG. 3, in this embodiment, the first movable plate 15, the second movable plate 16, and the third movable plate 17 are rectangular and have identical lengths. Moreover, a width of the third movable block 17 is greater than a width of the first movable block 15, and the width of the first movable block 15 is greater than a width of the second movable block 16, but the instant disclosure is not limited thereto. In some embodiments, the shapes, the lengths, and the widths of the first movable block 15, the second movable block 16, and the third movable block 17 may be configured differently according to actual product demands.

As shown in FIG. 1 and FIG. 3, the first movable block 15, the second movable block 16, and the third movable block 17 are spaced apart from each other, so that a region of the first outer layer 11 and a region of the first inner layer 13 which are between the first movable block 15 and the second movable block 16 form a first flexible portion 18. Accordingly, through the flexibility of the first flexible portion 18, the first movable block 15 and the second movable block 16 can swing relative to each other. A region of the first outer layer 11 and a region of the first inner layer 13 which are between the second movable block 16 and the third movable block 17 form a second flexible portion 19. Accordingly, through the flexibility of the second flexible portion 19, the second movable block 16 and the third movable block 17 can swing relative to each other. Moreover, in this embodiment, the second movable block 16 is between the first movable block 15 and the third movable block 17, and the first movable block 15 is nearer the flexible bent sheet 30 as compared with the second movable block 16 and the third movable block 17 (in other words, in this embodiment, a distance between the first movable block 15 and the flexible bent sheet 30 is less than a distance between the second movable block 16 and the flexible bent sheet 30 and is also less than a distance between the third movable block 17 and the flexible bent sheet 30).

As shown in FIG. 2 and FIG. 3, the second plate 20 comprises a connection sheet 21 and a base plate 25. The connection sheet 21 is integrally connected to the flexible bent sheet 30 and fixed on the base plate 25; for example, the connection sheet 21 may be assembled and fixed on the base plate 25 through adhering, buckling, locking, or other manners. In this embodiment, a keyboard 26 (for example a physical keyboard or a touchscreen keyboard) is further on the second plate 20. When the electronic device 1 is assembled on the first plate 10, the keyboard 26 may be connected to the electronic device 1 wiredly or wirelessly, so that the keyboard 26 can control the electronic device 1 to input messages.

As shown in FIG. 2 and FIG. 3, the flexible bent sheet 30 comprises a flexible outer layer 31, a flexible inner layer 32, and a solidified thermoplastic adhesive layer 33, and the solidified thermoplastic adhesive layer 33 is adhered between the flexible outer layer 31 and the flexible inner layer 32, so that the flexible bent sheet 30 is maintained in a bent state. In some embodiments, a thickness of the solidified thermoplastic adhesive layer 33 may be greater than a summation of a thickness of the first outer adhesive layer 12 and a thickness of the first inner adhesive layer 14, but the instant disclosure is not limited thereto.

Specifically, in some embodiments, the solidified thermoplastic adhesive layer 33 of the flexible bent sheet 30 is first heated to be shaped as a bent configuration and then is cooled and solidified. Therefore, after the solidified thermoplastic adhesive layer 33 is adhered between the flexible outer layer 31 and the flexible inner layer 32, the solidified thermoplastic adhesive layer 33 allows the flexible bent sheet 30 to be maintained in the bent state. Accordingly, the flexible bent sheet 30 can generate a torsion F toward the bending direction of the flexible bent sheet 30 continuously. Moreover, when the flexible bent sheet 30 is applied with a force to swing or bend toward a direction opposite to the bending direction, the torsion F increases. Descriptions are provided as below with accompanied drawings.

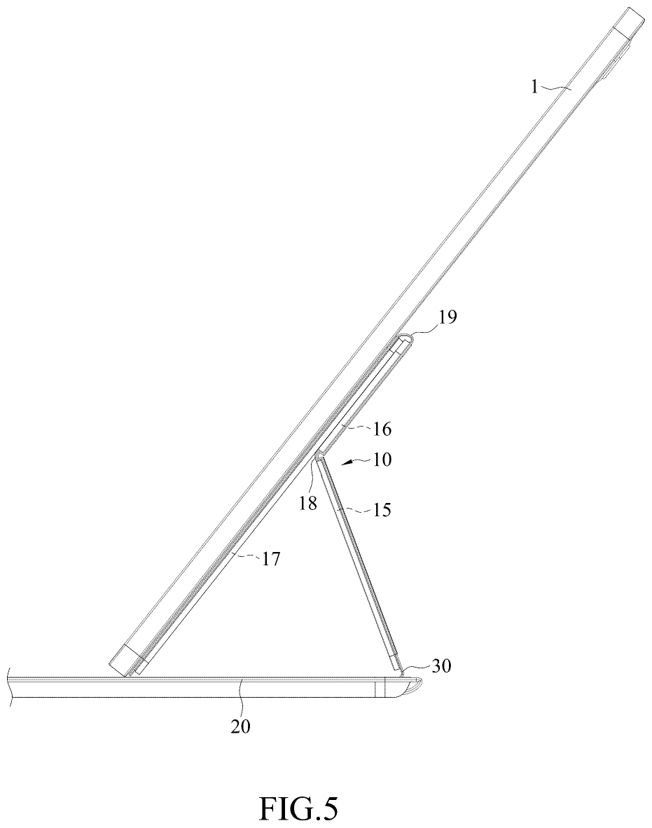

FIG. 4 illustrates an unfolded schematic view of the protective cover according to the exemplary embodiment of the instant disclosure. FIG. 5 illustrates a schematic view showing the operation of the protective cover according to the exemplary embodiment of the instant disclosure. Please refer to FIG. 3 to FIG. 5. Because the flexible bent sheet 30 is in the bent state, the flexible bent sheet 30 can generate the torsion F toward the bending direction of the flexible bent sheet 30; as shown in FIG. 4, the direction of the torsion F is a direction for overlaying the first plate 10 on the second plate 20. Moreover, when the first plate 10 and the second plate 20 are unfolded relative to each other, from the viewing angle of FIG. 4 for example, the first plate 10 swings and unfolds toward the clockwise direction (the direction indicated by the arrow L) with respect to the second plate 20, so that the flexible bent sheet 30 is applied with a force to swing or bend toward the direction opposite to the bending direction, thereby allowing the flexible bent sheet 30 to generate a much greater torsion F (as shown in FIG. 4, the direction of the torsion F is the counterclockwise direction which is opposite to the clockwise direction for unfolding the first plate 10), and the torsion F may be applied to the first movable block 15 which is nearest to the flexible bent sheet 30. Therefore, during the unfolding process of the first plate 10, the first movable block 15 swings toward the direction of the torsion F to drive other movable blocks (the second movable block 16 and the third movable block 17) to be moved relative to each other, so that the first movable block 15, the second movable block 16, and the third movable block 17 can be automatically folded as a predetermined configuration (as shown in FIG. 5) for being leaned against the electronic device 1. Hence, the user does not need to use his/her hands to apply forces on or adjust the movable blocks. Accordingly, the convenience in using the protective cover 2 according to some embodiments can be improved.

As shown in FIG. 5, the predetermined configuration may be that an angle between the first movable block 15 and the second plate 20 is acute angle, an angle between the first movable block 15 and the second movable block 16 is an obtuse angle, and the second movable block 16 and the third movable block 17 are side-by-side arranged and parallel to each other, so that the first movable block 15, the second movable block 16, and the third movable block 17 are folded as a three-dimensional stand. Therefore, when the electronic device 1 leans against the third movable block 17, the electronic device 1 can be supported by the third movable block 17 and arranged in an oblique configuration. However, the embodiments provided above are merely for illustrative purposes. In some other embodiments, the first movable block 15, the second movable block 16, and the third movable block 17 may be designed to have different folded configurations according to different application demands.

Moreover, when the first plate 10 and the second plate 20 are overlaid with each other (as shown in FIG. 3), the torsion F of the flexible bent sheet 30 can prevent the first plate 10 and the second plate 20 from being detached from each other easily, thereby improving the protection performance of the protective cover 2. For example, during the carrying of the protective cover 2, when the protective cover 2 is impacted by other objects which thus causes the first plate 10 and the second plate 20 to be unfolded relative to each other, the flexible bent sheet 30 can generate the torsion F to allow the first plate 10 and the second plate 20 to be overlaid with each other, so that dusts or foreign objects can be prevented from entering the electronic device 1 or from damaging the screen of the electronic device 1. Descriptions are provided as below with accompanied drawings to explain the manufacturing method of the protective cover 2.

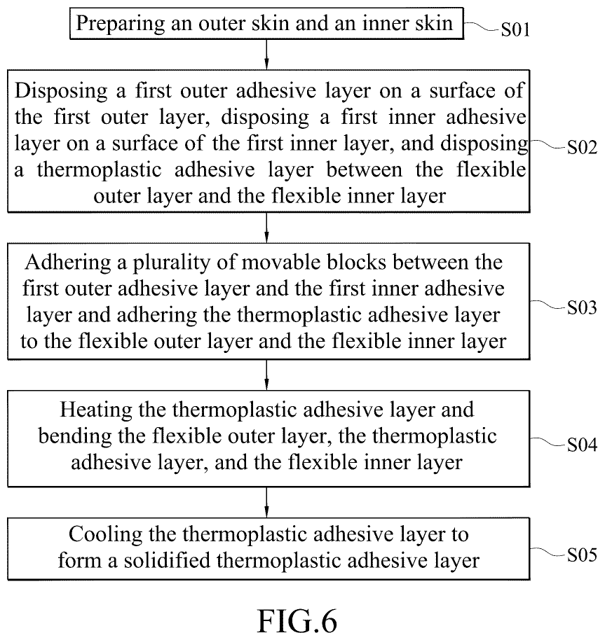

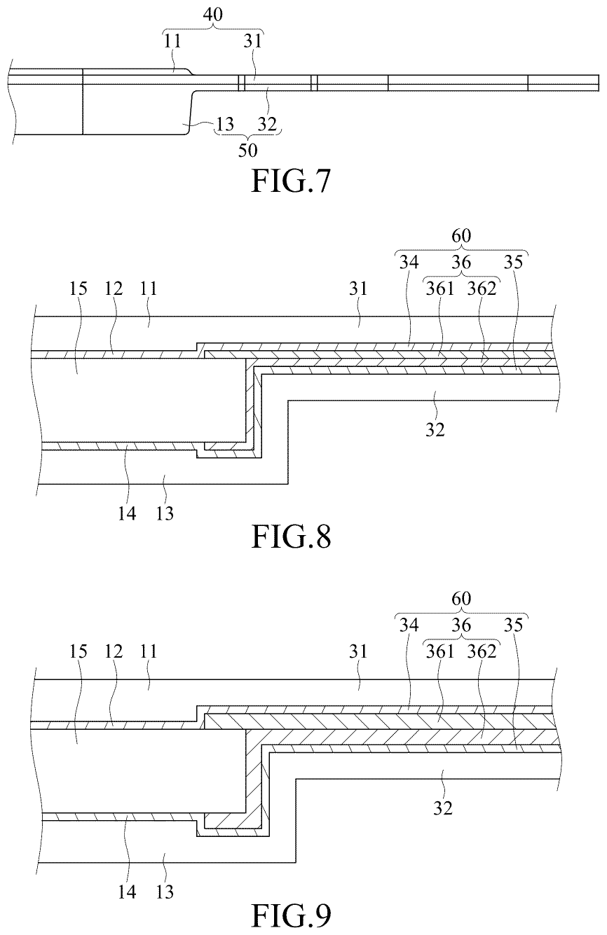

FIG. 6 illustrates a flowchart of a manufacturing method of a protective cover according to some exemplary embodiments of the instant disclosure. FIG. 7 illustrates a partial lateral view of the protective cover according to the exemplary embodiment of the instant disclosure. FIG. 8 illustrates a partial cross-sectional view of a thermoplastic adhesive layer of a protective cover according to a first embodiment of the instant disclosure. As shown in FIG. 6, according to one or some embodiments, the manufacturing method of the protective cover 2 comprises step S01 to step S05. In the step S01: preparing an outer skin 40 and an inner skin 50. Please refer to FIG. 7 and FIG. 8. The outer skin 40 comprises a first outer layer 11 and a flexible outer layer 31 integrally connected to each other, and the inner skin 50 comprises a first inner layer 13 and a flexible inner layer 32 integrally connected to each other. In some embodiments, the materials of the outer skin 40 and the inner skin 50 may be leather, silicone, plastic, or other soft materials.

As shown in FIG. 6, after the step S01, the step S02 can be executed: disposing a first outer adhesive layer 12 on a surface of the first outer layer 11, disposing a first inner adhesive layer 14 on a surface of the first inner layer 13, and disposing a thermoplastic adhesive layer 60 between the flexible outer layer 31 and the flexible inner layer 32. A thickness of the thermoplastic adhesive layer 60 may be greater than a summation of a thickness of the first outer adhesive layer 12 and a thickness of the first inner adhesive layer 14. Please refer to FIG. 7 and FIG. 8. In this embodiment, the thermoplastic adhesive layer 60 comprises an outer side adhesive layer 34, an inner side adhesive layer 35, and a thickening adhesive layer 36. The thickening adhesive layer 36 may be a single-layered adhesive structure or a multilayered adhesive structure; for example, in the embodiment shown in FIG. 8, the thickening adhesive layer 36 is a double-layered adhesive structure and comprises an outer thickening adhesive layer 361 and an inner thickening adhesive layer 362.

Further, as shown in FIG. 8, the first outer adhesive layer 12 and the outer side adhesive layer 34 may be integrally connected to each other to be the same adhesive layer having the same thickness, and the first inner adhesive layer 14 and the inner side adhesive layer 35 may be integrally connected to each other to be the same adhesive layer having the same thickness. Therefore, in the step S02, manually or using tools, the first outer adhesive layer 12 and the outer side adhesive layer 34 may be together coated on or attached to the surfaces of the first outer layer 11 and the flexible outer layer 31, and the first inner adhesive layer 14 and the inner side adhesive layer 35 may be together coated on or attached to the surfaces of the first inner layer 13 and the flexible inner layer 32. Next, the outer thickening adhesive layer 361 is coated on or attached to the surface of the outer side adhesive layer 34 and the inner thickening adhesive layer 362 is coated on or attached to the surface of the inner side adhesive layer 35. Accordingly, a stacked thickness of the outer side adhesive layer 34, the inner side adhesive layer 35, and the thickening adhesive layer 36 of the thermoplastic adhesive layer 60 is greater than the summation of the thickness of the first outer adhesive layer 12 and the thickness of the first inner adhesive layer 14.

In some embodiments, a thickness of the outer thickening adhesive layer 361 may be the same as a thickness of the outer side adhesive layer 34, and a thickness of the inner thickening adhesive layer 362 may be the same as a thickness of the inner side adhesive layer 35, so that the stacked thickness of the outer side adhesive layer 34, the inner side adhesive layer 35, and the thickening adhesive layer 36 is twice of the summation of the thickness of the first outer adhesive layer 12 and the thickness of the first inner adhesive layer 14 (as shown in FIG. 8). Alternatively, as shown in FIG. 9, in another embodiment, the thickness of the outer thickening adhesive layer 361 may be greater than the thickness of the outer side adhesive layer 34, and the thickness of the inner thickening adhesive layer 362 may be greater than the thickness of the inner side adhesive layer 35, so that the stacked thickness of the outer side adhesive layer 34, the inner side adhesive layer 35, and the thickening adhesive layer 36 is more than twice of the summation of the thickness of the first outer adhesive layer 12 and the thickness of the first inner adhesive layer 14.

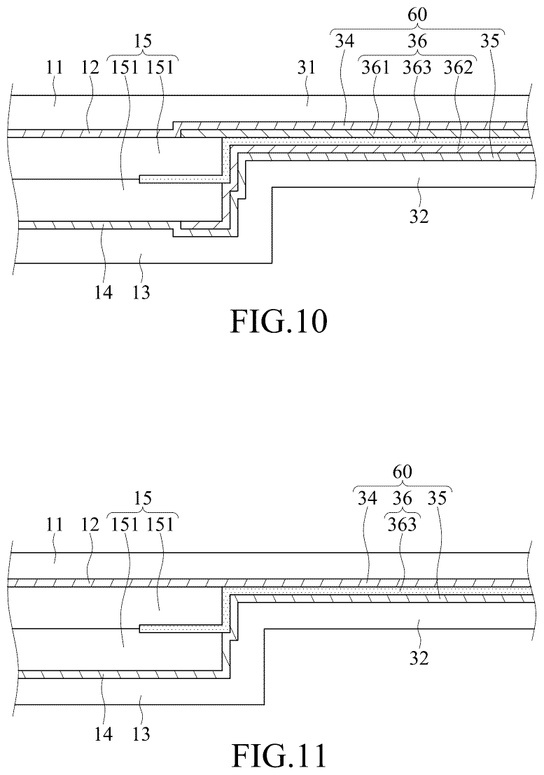

Alternatively, as shown in FIG. 10, in another embodiment, the thickening adhesive layer 36 of the thermoplastic adhesive layer 60 may be a three-layered adhesive structure and comprise an outer thickening adhesive layer 361, an inner thickening adhesive layer 362, and a middle thickening adhesive layer 363. In the step S02, the middle thickening adhesive layer 363 may be attached to the outer thickening adhesive layer 361 or the inner thickening adhesive layer 362. Alternatively, in some other embodiments, the thickening adhesive layer 36 of the thermoplastic adhesive layer 60 may be a single-layered adhesive structure and merely comprise one of the outer thickening adhesive layer 361, the inner thickening adhesive layer 362, and the middle thickening adhesive layer 363. For example, as shown in FIG. 11, in this embodiment, the thickening adhesive layer 36 of the thermoplastic adhesive layer 60 merely comprises the middle thickening adhesive layer 363.

Furthermore, it is understood that, for the sake of convenience and clarity in the description, thickness or sizes of the adhesive layers and the connection between the adhesive layers shown in FIG. 8 to FIG. 11 are illustrated in an exaggerated, omitted, or general manner to help a person skilled in the art with comprehension and reading the thickness relationships between the adhesive layers, and the sizes of the adhesive layers are not completely the actual sizes.

As shown in FIG. 6, after the step S02, the step S03 can be executed: adhering a plurality of movable blocks between the first outer adhesive layer 12 and the first inner adhesive layer 14 and adhering the thermoplastic adhesive layer 60 to the flexible outer layer 31 and the flexible inner layer 32. Please refer to FIG. 2. As mentioned above, the movable blocks comprise a first movable block 15, a second movable block 16, and a third movable block 17 spaced apart from each other. Therefore, after the movable blocks are adhered between the first outer adhesive layer 12 and the first inner adhesive layer 14, the movable blocks are swingable relative to each other.

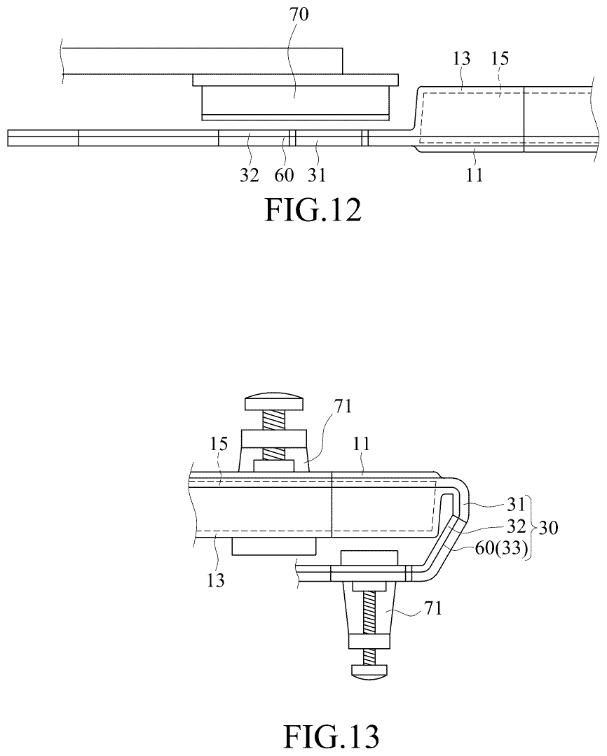

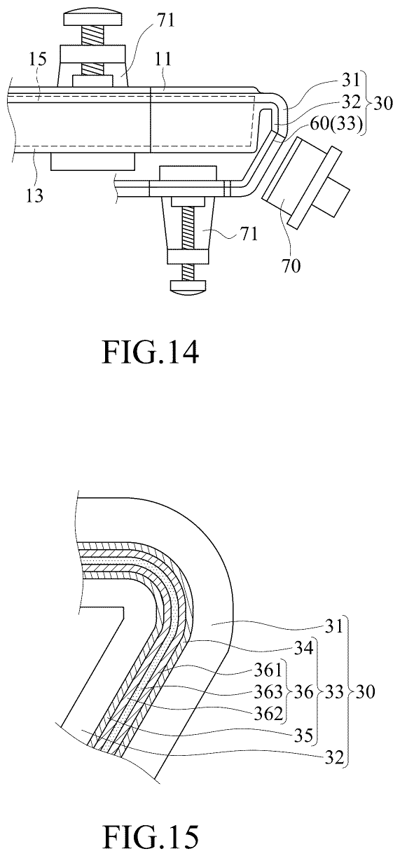

As shown in FIG. 6, after the step S03, the step S04 can be executed: heating the thermoplastic adhesive layer 60 and bending the flexible outer layer 31, the thermoplastic adhesive layer 60, and the flexible inner layer 32. Please also refer to FIG. 12 and FIG. 13. In the step S04, the thermoplastic adhesive layer 60 may be heated to a predetermined temperature using a heater 70 (as shown in FIG. 12), so that the thermoplastic adhesive layer 60 is softened to be in a deformable state. Next, the flexible outer layer 31, the thermoplastic adhesive layer 60, and the flexible inner layer 32 are bent to be in the predetermined bent state (as shown in FIG. 13) using a tool 71. Alternatively, in some embodiments, as shown in FIG. 14, in the step S04, the flexible outer layer 31, the thermoplastic adhesive layer 60, and the flexible inner layer 32 may be bent to be in the predetermined bent state using the tool 71, and then the thermoplastic adhesive layer 60 is heated to the predetermined temperature to be softened using the heater 70.

As shown in FIG. 6, after the step S04, the step S05 can be executed: cooling the thermoplastic adhesive layer 60 to form a solidified thermoplastic adhesive layer 33. For example, in the step S05, the thermoplastic adhesive layer 60 may be rested for a period to cool the thermoplastic adhesive layer 60 naturally, or in some embodiments, the cooling of the thermoplastic adhesive layer 60 may be accelerated using a cooling device (for example, a fan). Therefore, the thermoplastic adhesive layer 60 can be solidified to form the solidified thermoplastic adhesive layer 33 which is maintained in the bent state (as shown in FIG. 13 or FIG. 14). Therefore, the flexible outer layer 31, the solidified thermoplastic adhesive layer 33, and the flexible inner layer 32 can form a flexible bent sheet 30, and the flexible bent sheet 30 is maintained in the bent state (as shown in FIG. 3).

Accordingly, please refer to FIG. 3 and FIG. 15. Because the solidified thermoplastic adhesive layer 33 is formed by solidifying the thermoplastic adhesive layer 60, the solidified thermoplastic adhesive layer 33 of the flexible bent sheet 30 also comprises the outer side adhesive layer 34, the inner side adhesive layer 35, and the thickening adhesive layer 36, and the thickening adhesive layer 36 is adhered between the outer side adhesive layer 34 and the inner side adhesive layer 35. Moreover, as mentioned above, the thickening adhesive layer 36 of the solidified thermoplastic adhesive layer 33 may be a multilayered adhesive structure and comprise at least two selected from the group consisting of the outer thickening adhesive layer 361, the inner thickening adhesive layer 362, and the middle thickening adhesive layer 363. Alternatively, in some other embodiments, the thickening adhesive layer 36 comprises merely one of the outer thickening adhesive layer 361, the inner thickening adhesive layer 362, and the middle thickening adhesive layer 363. Therefore, the thickness of the solidified thermoplastic adhesive layer 33 is greater than the summation of the thickness of the first outer adhesive layer 12 and the thickness of the first inner adhesive layer 14.

Please refer to FIG. 4 and FIG. 15. In some embodiments, because the thickness of the solidified thermoplastic adhesive layer 33 is greater than the summation of the thickness of the first outer adhesive layer 12 and the thickness of the first inner adhesive layer 14, the solidified thermoplastic adhesive layer 33 is rigid enough to provide the torsion F. Therefore, during the unfolding process of the first plate 10, the torsion F can drive the movable blocks to be folded as the predetermined configuration (as shown in FIG. 5). Moreover, the thicker the solidified thermoplastic adhesive layer 33 of the flexible bent sheet 30, the greater the torsion F generated by the flexible bent sheet 30 due to the applied force. Hence, the thickness of the solidified thermoplastic adhesive layer 33 can be adjusted according to actual product demands.

Moreover, in the step S03, a region of the thickening adhesive layer 36 may be adhered to a movable block adjacent to the flexible bent sheet 30. As shown in FIG. 2, the first movable block 15 is nearer to the flexible bent sheet 30 as compared with the second movable block 16 and the third movable block 17. The portion of the thickening adhesive layer 36 may be adhered to the surface or the interlayer of the first movable block 15. Therefore, when the flexible bent sheet 30 generates the torsion F, the torsion F can be transmitted to the first movable block 15 more quickly.

For example, as shown in FIG. 8 and FIG. 9, in this embodiment, the thickening adhesive layer 36 comprises the outer thickening adhesive layer 361 and the inner thickening adhesive layer 362, one side of the outer thickening adhesive layer 361 and one side of the inner thickening adhesive layer 362 are adhered to two opposite surfaces of the first movable block 15, respectively. Alternatively, as shown in FIG. 10, in the embodiment, the first movable block 15 comprises a plurality of sheets 151, and the thickening adhesive layer 36 comprises the outer thickening adhesive layer 361, the inner thickening adhesive layer 362, and the middle thickening adhesive layer 363, one side of the middle thickening adhesive layer 363 is sandwiched and adhered between the sheets 151, and one side of the outer thickening adhesive layer 361 and one side of the inner thickening adhesive layer 362 are adhered to two opposite surfaces of the first movable block 15, respectively. Alternatively, as shown in FIG. 11, in the embodiment, the thickening adhesive layer 36 merely comprises the middle thickening adhesive layer 363, and one side of the middle thickening adhesive layer 363 is sandwiched and adhered between the sheets 151 of the first movable blocks 15.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A protective cover for an electronic device, wherein the protective cover comprises a first plate, a flexible bent sheet, and a second plate, the flexible bent sheet is connected between the first plate and the second plate, so that the first plate and the second plate are selectively overlaid or unfolded relative to each other; wherein
the first plate comprises a first outer layer, a first inner layer, and a plurality of movable blocks, a first outer adhesive layer is on a surface of the first outer layer, a first inner adhesive layer is on a surface of the first inner layer, the movable blocks are adhered between the first outer adhesive layer and the first inner adhesive layer, and the movable blocks are spaced apart from each other, so that the movable blocks are selectively swingable relative to each other;
the flexible bent sheet comprises a flexible outer layer, a flexible inner layer, and a solidified thermoplastic adhesive layer, and the solidified thermoplastic adhesive layer is adhered between the flexible outer layer and the flexible inner layer, so that the flexible bent sheet is maintained in a bent state.

2. The protective cover according to claim 1, wherein a thickness of the solidified thermoplastic adhesive layer is greater than a summation of a thickness of the first outer adhesive layer and a thickness of the first inner adhesive layer.

3. The protective cover according to claim 2, wherein the thickness of the solidified thermoplastic adhesive layer is two times or more of the summation of the thickness of the first outer adhesive layer and the thickness of the first inner adhesive layer.

4. The protective cover according to claim 1, wherein the solidified thermoplastic adhesive layer comprises an outer side adhesive layer, an inner side adhesive layer, and a thickening adhesive layer, and the thickening adhesive layer is adhered between the outer side adhesive layer and the inner side adhesive layer.

5. The protective cover according to claim 4, wherein the outer side adhesive layer is integrally connected to the first outer adhesive layer, and the inner side adhesive layer is integrally connected to the first inner adhesive layer.

6. The protective cover according to claim 1, wherein the movable blocks comprise a first movable block and a second movable block, the first movable block is nearer to the flexible bent sheet as compared with the second movable block, and a region of the solidified thermoplastic adhesive layer is adhered to the first movable block.

7. The protective cover according to claim 1, wherein the movable blocks comprise a first movable block adjacent to the flexible bent sheet, the first movable block comprises a plurality of sheets stacked with each other, and a region of the solidified thermoplastic adhesive layer is sandwiched and adhered between the sheets.

8. The protective cover according to claim 1, wherein the movable blocks comprise a first movable block adjacent to the flexible bent sheet, and the first movable block comprises a plurality of sheets stacked with each other; the solidified thermoplastic adhesive layer comprises an outer thickening adhesive layer, an inner thickening adhesive layer, and a middle thickening adhesive layer, the middle thickening adhesive layer is adhered between the outer thickening adhesive layer and the inner thickening adhesive layer, one side of the middle thickening adhesive layer is sandwiched and adhered between the sheets, and one side of the outer thickening adhesive layer and one side of the inner thickening adhesive layer are adhered to two opposite surfaces of the first movable block, respectively.

9. The protective cover according to claim 1, wherein the flexible bent sheet is adapted to generate a torsion, and a direction of the torsion is a direction for overlaying the first plate on the second plate.

10. The protective cover according to claim 1, wherein the movable blocks comprise a first movable block, a second movable block, and a third movable block, the second movable block is between the first movable block and the third movable block, and the first movable block is nearer to the flexible bent sheet as compared with the second movable block and the third movable block.

11. The protective cover according to claim 1, wherein the second plate comprises a connection sheet and a base plate, and the connection sheet is integrally connected to the flexible bent sheet and fixed on the base plate.

12. The protective cover according to claim 1, wherein a keyboard is on the second plate.

13. A manufacturing method of a protective cover for an electronic device, wherein the manufacturing method comprises:
step (a): preparing an outer skin and an inner skin, wherein the outer skin comprises a first outer layer and a flexible outer layer integrally connected to each other, and the inner skin comprises a first inner layer and a flexible inner layer integrally connected to each other;
step (b): disposing a first outer adhesive layer on a surface of the first outer layer, disposing a first inner adhesive layer on a surface of the first inner layer, and disposing a thermoplastic adhesive layer between the flexible outer layer and the flexible inner layer;
step (c): adhering a plurality of movable blocks between the first outer adhesive layer and the first inner adhesive layer and adhering the thermoplastic adhesive layer to the flexible outer layer and the flexible inner layer, wherein the movable blocks are spaced apart from each other, so that the movable blocks are selectively swingable relative to each other;
step (d): heating the thermoplastic adhesive layer and bending the flexible outer layer, the thermoplastic adhesive layer, and the flexible inner layer; and
step (e): cooling the thermoplastic adhesive layer to form a solidified thermoplastic adhesive layer, so that the flexible outer layer, the solidified thermoplastic adhesive layer, and the flexible inner layer form a flexible bent sheet, and the flexible bent sheet is maintained in a bent state.

14. The manufacturing method according to claim 13, wherein a thickness of the thermoplastic adhesive layer is greater than a summation of a thickness of the first outer adhesive layer and a thickness of the first inner adhesive layer.

15. The manufacturing method according to claim 13, wherein in the step (d), the thermoplastic adhesive layer is first heated and then the flexible outer layer, the thermoplastic adhesive layer, and the flexible inner layer are bent.

16. The manufacturing method according to claim 13, wherein in the step (d), the flexible outer layer, the thermoplastic adhesive layer, and the flexible inner layer are first bent and then the thermoplastic adhesive layer is heated.

17. The manufacturing method according to claim 13, wherein the thermoplastic adhesive layer comprises an outer side adhesive layer, an inner side adhesive layer, and a thickening adhesive layer; the step (b) comprises disposing the outer side adhesive layer on a surface of the flexible outer layer, disposing the inner side adhesive layer on a surface of the flexible inner layer, and adhering the thickening adhesive layer to the outer side adhesive layer or the inner side adhesive layer.

18. The manufacturing method according to claim 13, wherein the movable blocks comprise a first movable block and a second movable block, and the first movable block is nearer to the flexible outer layer as compared with the second movable block; in the step (c), a region of the thermoplastic adhesive layer is further adhered to the first movable block.
